(19) United States
(12) Patent Application Publication
(10) Pub. No.: US 2008/0156730 A1
(43) Pub. Date: Jul. 3, 2008

(54) Permeate Spacer Module

(75) Inventor: Nicolas Heinen, Lyngby (DK)

Correspondence Address: MICHAUD-DUFFY GROUP LLP, 306 INDUSTRIAL PARK ROAD, SUITE 206, MIDDLETOWN, CT, 06457, US

(73) Assignee: Alfa Laval Corporate AB, Lund (SE)

(21) Appl. No.: 11/884,135

(22) PCT Filed: Feb. 23, 2006
(86) PCT No.: PCT/SE06/00245

§ 371 Date: Feb. 7, 2008

Related U.S. Application Data
(60) Provisional application No. 60/657,547, filed on Feb. 28, 2005.

(30) Foreign Application Priority Data
Feb. 28, 2005 (SE) 0500470-0

(51) Int. Cl. B01D 63/00; B01D 35/00; C02F 3/00

(52) U.S. Cl. 210/650; 210/500.21; 210/500.25; 210/170.01

(57) ABSTRACT

The invention relates to a permeate spacer module comprising a spacer and at least one collection device, which spacer comprises of support members which being spaced apart by at least one inserted element forming flow space or flow channels between the support members and the inserted element for guiding permeates to at least one permeate collection device connected to the flow space or the flow channels. The invention relates further to a membrane system comprising the permeate space module, a process for operating the membrane system, use of the membrane system, a membrane plant and use of the membrane plant.

### CROSS-REFERENCE TO RELATED APPLICATIONS

This application is entitled to the benefit of and incorporates by reference essential subject matter disclosed in International Application No. PCT/SE2006/000245 filed on Feb. 23, 2006 and Swedish Patent Application No. 0500470-0 filed on Feb. 28, 2005 and U.S. Patent Application No. 60/657,547 filed on Feb. 28, 2005.

### FIELD OF THE INVENTION

The present invention relates to a permeate spacer module, a membrane system, a process for operating the membrane system, use of the membrane system, a membrane plant and use of the membrane plant.

### BACKGROUND OF INVENTION

The fluids passing through a membrane have to be transported to the membrane or be in contact with the membrane before passing the membrane. After passage the fluids are collected in a draining system and transported out of the system. Many membranes utilise spacers for transportations of fluids to and from the membranes. EP 11201150, VVO 2004/103535 and WO 2004/103536 disclose membrane spacers.

The draining system, which is collecting the fluids, can be an obstruction for the fluids, and thereby generating a counter pressure resulting in creating a pressure drop. The counter pressure may limit the flux through the membrane and the pressure drop may cause fouling of the membrane and limit its performance.

Thus, one object of the present invention is to improve the design of the draining system and thus increase the performance of the membrane.

Another further object is to provide membranes having improved energy balance.

### SUMMARY OF THE INVENTION

Membranes can be used for microfiltration, ultrafiltration, nanofiltration or reverse osmosis. Microfiltration is the coarsest of the membrane filtration classes typically in the range of 0.1 to 10 micrometer (μm). Ultrafiltration membranes are classified by the molecular weight cut off which is defined as the molecular weight of the smallest molecule, 90% of which is retained by the membrane. Ultrafiltration range spans from 1000 to 500,000 molecular weight cut off. Nanofiltration membranes retain solute molecules having a molecular weight ranging from 100 to 1,000. Reverse osmosis involves the tightest membranes, which are capable of separating even the smallest solute molecules.

The fluids, which have passed a membrane or a membrane-film, are defined as permeate. The fluids, which are left, are defined as concentrate or retentate hereinafter defined as concentrate. Membranes can be spaced apart by inserted elements, spacers or spacer elements. Spacers or inserted elements can be manufactured of corrugated material, of pleated material, casted material, extruded material, or machined material providing a structure, which allows the fluids free flow to a collecting system or collecting device.

Hereinafter spacer defines the member spacing apart membranes or membrane films, the spacer comprises of support members and of inserted elements. Inserted element defines the element spacing apart the support members.

The invention relates to a permeate spacer module comprising a spacer and at least one collection device, which spacer comprises of at least one inserted element and of support members selected from at least one member of the group consisting of support surface units (13), solid surface material(s) having perforations, porous surface material(s), composite surface material(s) having perforations or pores or combinations thereof, sandwich surface material(s) having perforations or pores, or combinations thereof, the support members being spaced apart by the at least one inserted element forming flow space, or flow channels between the support members and the inserted element for guiding permeates to the at least one permeate collection device connected to the permeate spacer module.

The shape of pores or of perforations, the frequency of them or the amount can be adjusted depending of the pressure range, viscosity or temperature of the fluids. The perforations can be holes, slots, slits, or combinations thereof.

Inserted elements can be longitudinal walls, corrugated sheet, pleated sheet, casted sheet, moulded sheet, extruded sheet, sheet having ducts, sheet having cut or flat peaks, single distance aids, or combinations thereof.

The flow space between the support members and the inserted elements is forming passages, flow space, or flow channels. The passages, the flow space, or the flow channels may be connected or attached to at least one permeate collection device. The passages, flow space or flow channels can be extending along each other according to one alternative embodiment. According to yet another embodiment are the inserted element forming passages, flow space or flow channels herein after called flow channels, which flow channels are extending parallel along each other. The permeate collection device can be a expanded frame or any means for collection of permeates or the permeate collection device may be of tubular form or of U-shaped extruded form. The U-shaped extruded form collection device may be connected to the flow channels on the open end of the U-shape and may cover all parallel flow channels on at least one side of the spacer module, and to guide and collect permeate from the flow channels. The tubular collection device may be connected to the parallel flow channels and the permeate may pass into the tube through holes, slits, slots or through any type of passage means in the tube, or the tube may have a cut along the tube to facilitate connection to the permeate spacer module and to guide and collect permeate from the flow channels. The flow channels may be attached or connected perpendicular to the at least one collection device. According to another alternative may the at least one collection device be connected or attached all around the spacer and the flow space being communicating with the at least one collection device for the permeates to be collected before transport to storage or further treatment.

The permeate spacer can have a thickness of at least 0.1 mm, the thickness can be as large as less than or equal to about 20 mm. According to one alternative embodiment can the thickness be at least 0.2 mm, and yet another alternative embodiment the thickness can be at least 0.5 mm. According to yet another alternative embodiment the thickness can be within the range of from about 0.1 mm to about 20 mm. According to yet another alternative embodiment the thickness can be within the range of from about 0.5 mm to about 15 mm. According to yet another alternative embodiment the thickness can be within the range of from about 1 mm to about 5 mm. According to yet another alternative embodiment the thickness can be within the range of from about 0.1 mm to about 2.0 mm. According to yet another alternative embodiment the thickness can be within the range of from about 0.5 mm to about 1.5 mm.

The support members and inserted elements can be manufactured of the same material, or the support material can be manufactured of one material and the inserted elements of another material. The material can be metal, ceramic, plastic, composite, paper, porous material, polymeric, or combinations thereof. According to one alternative embodiment the material can be selected from at least one of the materials of the group consisting of polyolefin elastomeres, ethylene vinyl acetate copolymers, ethylene vinyl acetate terpolymers, styrene-ethylene/butylenes-styrene block copolymers, polyurethanes, polybuthylene, polybuthylene copolymers, polyisoprene, polyisopren copolymers, acrylate, silicones, natural rubber, polyisobutylene, butylrubber, polypropylene, polypropylene copolymers, polyethylene, polyethylene copolymers, polycarbonate, flouropolymers, polystyrene, acrylonitrile-butadien-styrene copolymers, nylons, polyvinylchloride, and copolymers and blends thereof.

The invention relates further to a membrane system comprising a permeate spacer to which membranes or membrane films can be attached on both sides of the permeate spacer.

The membrane can be welded onto the spacer, glued on the spacer, casted together with the spacer or extruded together as one membrane unit, fixed on the spacer or be a part of the spacer construction.

The system can comprise at least one permeate collector device, which can be of tubular form or of U-shaped extruded form, and the sides of the system can be welded or glued, and can be provided with at least one support list, or support strip.

The invention relates further to a process for collecting permeates comprising following steps,
i) contacting a membrane system according to the invention to fluids, transferring permeates through a membrane;
ii) creating a flow of permeates through the passages, the flow space or the flow channels within the permeate spacer module; and
iii) collecting the permeate in the at least one permeate collecting device connected or attached to the, passages, the flow space or the flow channels.

The process may also comprise an extra step: iv) transferring the permeates collected in step iii) by hydrostatic pressure to a collection tank, or a container, or a well.

The invention relates to use of a membrane system comprising a permeate spacer and membrane films for treatment of wastewater, seawater, surface water or well water.

The membrane system can be used as a pre-treatment of water, such as for example seawater, surface water or well water, before a desalination plant of the reverse osmosis type. The membrane system can also be used in preparation of drinking water from surface water or well water. The membrane system can be used as a pre-treatment or as a final treatment of water. In such a case the membranes will be installed in a tank where the hydrostatic pressure will be used as trans membrane pressure, TMP.

Due to the low-pressure drop in the membrane system it is possible to treat water with nanofiltration membranes for the removal of divalent ions like calcium, magnesium etc., or low organic molecules like pesticides. The membrane system can also be used for sterile filtration, clarification, or concentration of high molecule weights. The membrane system can be used for processing of vine, beer, fruit juice concentration, sterile filtration of milk.

The permeate spacer provides a good support for membranes, and the passages, the flow space or the flow channels allows a free flow or a flow of the fluids without formation of obstructions generating counter pressures. The size of the permeate spacer can be adapted to the application and can be integrated in different configurations like plate and frame membranes, or a membrane bioreactor (MBR) where the pressure drop on the permeate side has to be kept down to avoid the formation of a counter pressure especially for high flux permeate rates.

The membrane system can be used for different types of constructions and including all pressure ranges, comprising micro filtration, ultra filtration, nanofiltration or reverse osmosis.

In the plate and frame membrane construction the permeate spacer can be used as a membrane support plate.

The invention relates to a membrane plant comprising a membrane system according to the invention, and the membrane plant comprises also of a collection tank, or of a container, or of a well.

In the membrane plant or membrane bioreactor may the membrane system be placed within a biological treatment tank, and the collection tank, or the container, or the well may be connected to the membrane system outside the biological treatment tank. The collected permeates from the at least one permeate collection device may be transferred by hydrostatic pressure to the collection tank, or the container, or the well, which collection tank, or container, or well being connected to the at least one collection device inside the biological treatment tank. The collected permeates may be stored or sent for use.

The membrane plant may also comprise a pump for transporting a part of the collected permeates from the collection tank, or the container, or the well back to the biological treatment tank. The membrane plant may according to another alternative comprise that the membrane system is placed in a continuous flow of fluids to be treated, in treatment tank which is not a biological treatment tank, which maybe for instance the open sea for treatment of salty seawater, or a treatment tank for other types of fluids in food industries, chemical plants, pulp and paper industries etc.

The invention relates to use of a membrane plant for treatment of wastewater, seawater, surface water or well water.

Due to the low-pressure drop in the membrane system it is possible to treat water with nanofiltration membranes for the removal of divalent ions like calcium, magnesium etc., or low organic molecules like pesticides just by using the hydrostatic pressure.

The invention is intended to be explained in more detail in the following by means of the attached drawings.

### BRIEF DESCRIPTION OF THE DRAWINGS

FIG. 1 show a schematic part view of one alternative embodiment of the permeate spacer.

FIG. 2 show a schematic part view of another alternative embodiment of the membrane system.

FIG. 3 show a schematic part view of another alternative embodiment of the inserted element.

FIG. 4 show a schematic part view of one alternative embodiment of the membrane plant.

FIG. 5 show a schematic part view of another alternative embodiment of the membrane plant.

### DETAILED DESCRIPTION OF THE PREFERRED EMBODIMENTS OF THE INVENTION

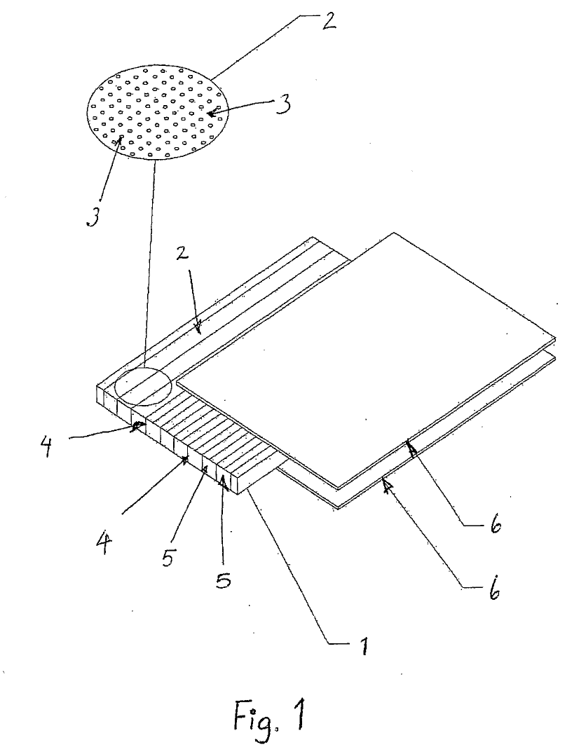

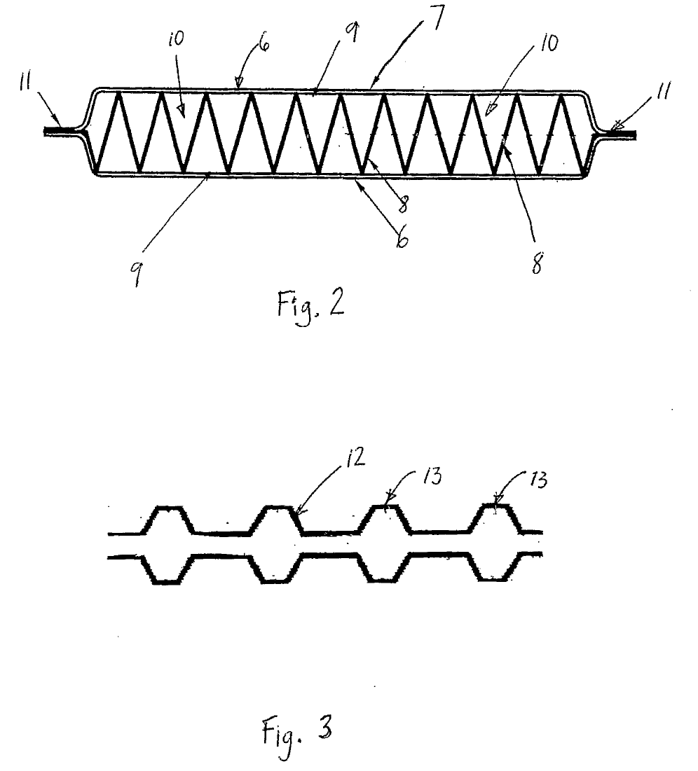

FIG. 1 is showing perspective view of spacer 1, the spacer is an extruded spacer having extruded support members 2, which support members are provided with perforations 3. According this alternative embodiment inserted elements 4 are longitudinal walls forming flow space 5 between the support members 2 and the longitudinal walls. Membranes 6 are attached on both sides of spacer 1. FIG. 2 is showing a cross view of one alternative membrane system 7, wherein pleated sheet 8 is spacing apart support members 9 forming flow space in form of parallel passages 10. On top of support members 9 are membranes 6 attached. Membrane system 7 is welded together on at least two sides 11. FIG. 3 is showing a cross view of one alternative embodiment of inserted element 12 having flat peaks 13 functioning as support surface units.

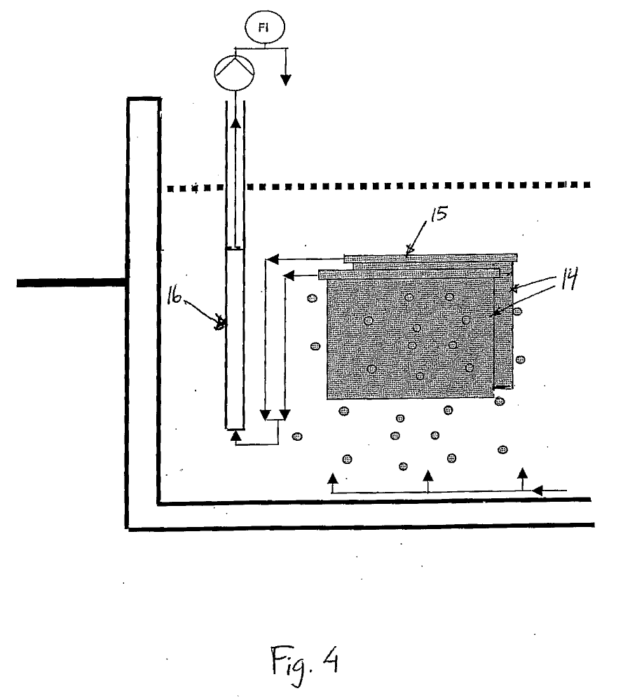

FIG. 4 is showing one alternative embodiment of a membrane plant according to the invention. According to this embodiment membrane systems 14 are placed in a biological treatment tank. Membrane system 14 is constructed by welding three sides of the membrane system. The forth side ends with a collection device 15 which can be of tubular form or of U-shaped extruded form. Each of the welded sides can be equipped with support lists, support strips or anything else (not shown in FIG. 4), which would hold the membrane system spread out to enables as large area as possible. Fluids, i.e. permeates and air is transported within the passages (not shown in FIG. 4) to the collection device 15, from the collection device is the fluids transferred to a vertical tube 16 by the aid of hydrostatic pressure. The bottom of tube 16 is at a lower level than the membrane system to enable the hydrostatic pressure to develop. The top of tube 16 is above the water level and this end of the tube is open to let out air.

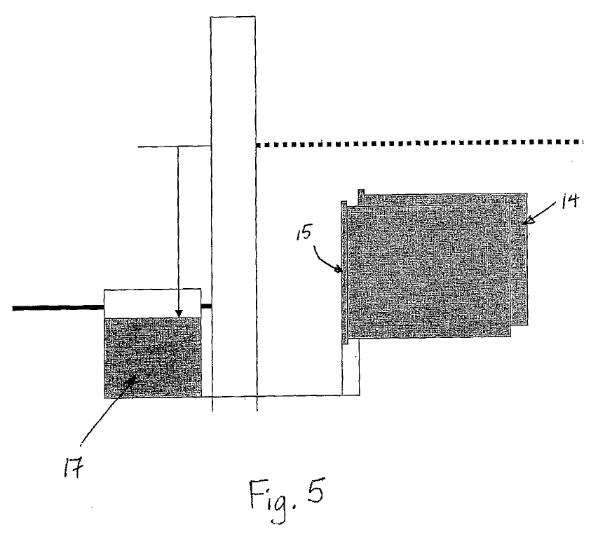

FIG. 5 is showing another alternative embodiment of the membrane plant. The membrane system is totally immerged in a biological treatment tank under the water level in the tank. According to this embodiment a collection tank or well 17 is placed outside the biological treatment tank. The water level difference between the outlet of the permeate collection device 15 and the water level in the tank is generating a hydrostatic pressure which is enough to generate a trans-membrane pressure able to generate a liquid flow through the membrane in the permeate collecting spacer. From this permeate collecting spacer the liquid is collected in one, two or several collection devices 15, which can be of the tubular form, U-shaped extruded form or other geometric configuration. The permeate is by gravity going to a well or a collection tank 17, where the water level is lower as the water level in the main tank. This water level difference is generating the hydrostatic pressure necessary to run the membrane system. The hydrostatic pressure can be regulated by the control of the water level in the well 17.

In the following examples an investigation of flow rate and of flux rate over time is carried out and a comparison is made between a conventional spiral wound membrane spacer and the membrane system according to one alternative embodiment of the present invention. The purpose of the Examples is to illustrate the performance of the permeate spacer and the permeate system, and is not intended to limit the scope of invention.

### Example 1

Tests were carried out using the membrane plant disclosed in FIG. 4. Permeate flow and permeate flux were monitored during 16 days. During the test the membrane system was able to run without applying a pressure on the membrane or using vacuum. The hydrostatic pressure was enough to press the water through the membrane. Variation in the hydrostatic pressure can regulate the flow through the membrane. These variations can be controlled by the water level in the tank or in the well. The area of the membrane system was 3.753 m² and the air temperature was between −5° C. and 5° C. during the test period. The results are summarised in Table 1.

TABLE 1

| | | | Hydrostatic | Total | | Permeate flux |
|---|---|---|---|---|---|---|
| | Permeate | Tank level | Pressure | permeate | Water | at 0.1 Bar and |
| | Level H1 | H2 | H1 − H2 | flow | temperature | 25° C. |
| Day No. | [m] | [m] | [Bar] | [dm³/h] | [° C.] | [dm³/(m² × h)] |
| 1 | 1.3 | 0.55 | 0.075 | 35.6 | 7.8 | 19 |
| 2 | 1.3 | 0.55 | 0.075 | 38.8 | 7.8 | 21 |
| 3 | 1.3 | 0.55 | 0.075 | 39.8 | 7.8 | 21 |
| 4 | 1.3 | 0.58 | 0.072 | 29.4 | 8.4 | 16 |
| 5 | 1.3 | 0.60 | 0.070 | 26.6 | 8.8 | 15 |
| 6 | 1.3 | 0.54 | 0.076 | 18.3 | 8.0 | 10 |
| 7 | 1.3 | 0.55 | 0.075 | 24.1 | 8.2 | 13 |
| 8 | 1.3 | 0.60 | 0.070 | 24.8 | 8.6 | 14 |
| 9 | 1.3 | 0.62 | 0.068 | 24.9 | 8.7 | 14 |
| 10 | 1.3 | 0.55 | 0.075 | 24.5 | 8.1 | 13 |
| 11 | 1.3 | 0.60 | 0.070 | 21.9 | 7.8 | 13 |
| 12 | 1.3 | 0.65 | 0.065 | 20.4 | 8.0 | 13 |
| 13 | 1.3 | 0.62 | 0.068 | 20.5 | 8.0 | 12 |
| 14 | 1.3 | 0.62 | 0.068 | 20.0 | 8.1 | 12 |
| 15 | 1.3 | 0.62 | 0.068 | 21.0 | 8.1 | 12 |
| 16 | 1.3 | 0.62 | 0.068 | 20.2 | 8.1 | 12 |

### Example 2 (Comparison)

In this example a conventional spiral wound spacer element attached to a collecting device was compared to a permeate spacer according to FIG. 1 attached to a collecting device. Both the spiral wound spacer element and the permeate spacer were provided with membranes on each side. The hydrostatic pressure was 1.2 m and the measured flux for the conventional spacer was 16 dm³/m²×h and the flux with the permeate spacer was 100 dm³/m²×h showing that the permeate spacer of the invention giving a ratio of 6.25 to the conventional spacer. The conclusion of the results are that even at low flux the importance of the free flow on the permeate side and at higher flux level the ratio increase.

What is claimed in:

1-27. (canceled)

28. A permeate spacer module comprising a spacer and at least one collection device, which spacer comprises of at least one inserted element and of support members selected from at least one member of the group consisting of support surface units, solid surface material(s) having perforations, porous surface material(s), composite surface material(s) having perforations or pores or combinations thereof, sandwich surface material(s) having perforations or pores, or combinations thereof, the support members being spaced apart by the at least one inserted element forming flow space, passages or flow channels between the support members and the inserted element for guiding permeates to the at least one permeate collection device connected or attached to the permeate spacer module.

29. The permeate spacer module according to claim 28, wherein the flow channels being parallel to each other and perpendicular connected or attached to the at least one permeate collection device.

30. The permeate spacer module according to claim 28, wherein the flow space being connected or attached to the at least one permeate collection device, and the at least one permeate collection device being connected or attached to the spacer all around the side(s) of the spacer.

31. The permeate spacer module according to claim 28, wherein the inserted elements being longitudinal walls, corrugated sheets, pleated sheets, casted sheets, moulded sheets, extruded sheets, sheets having ducts, sheets having cut or flat peaks, single distance aids, or combinations thereof.

32. The permeate spacer module according to claim 28, wherein the support members are of solid material having perforations or of porous material.

33. The permeate spacer module according to claim 28, wherein the perforations are holes, slots, slits, or combinations thereof.

34. The permeate spacer module according to claim 28, wherein the support members and the at least one inserted element, respectively being made of material(s) selected from at least one of the materials of the group consisting of metal, ceramic, plastic, composite, paper, cellulose, porous material, polymeric, glass, glass fibre or combinations thereof.

35. The permeate spacer module according to claim 34, wherein the support members and the at least one inserted element, respectively being made of a material selected from at least one of the materials of the group consisting of polyolefin elastomeres, ethylene vinyl acetate copolymers, ethylene vinyl acetate terpolymers, styrene-ethylene/butylenes-styrene block copolymers, polyurethanes, polybuthylene, polybuthylene copolymers, polyisoprene, polyisopren copolymers, acrylate, silicones, natural rubber, polyisobutylene, butylrubber, polypropylene, polypropylene copolymers, polyethylene, polyethylene copolymers, polycarbonate, flouropolymers, polystyrene, acrylonitrile-butadien-styrene copolymers, nylons, polyvinylchloride, and copolymers and blends thereof.

36. The permeate spacer module according to claim 28, wherein the support members are spaced apart within a distance of at least 0.1 mm.

37. The permeate spacer module according to claim 28, wherein the support members are spaced apart within a distance of less than about 20 mm.

38. The permeate spacer module according to claim 28, wherein the support members are spaced apart within a distance within the range of from about 1 mm to about 5 mm.

39. The permeate spacer module according to claim 28, wherein the at least one permeate collector being an expanded frame, or any means for collection of permeates.

40. The permeate spacer module according to claim 28, wherein the expanded frame being of tubular form or being of U-shaped extruded form.

41. A membrane system comprising a spacer and at least one collection device, which spacer comprises of at least one inserted element and of support members selected from at least one member of the group consisting of support surface units, solid surface material(s) having perforations, porous surface material(s), composite surface material(s) having perforations or pores or combinations thereof, sandwich surface material(s) having perforations or pores, or combinations thereof, the support members being spaced apart by the at least one inserted element forming flow space, passages or flow channels between the support members and the inserted element for guiding permeates to the at least one permeate collection device connected or attached to the permeate spacer module; and
a permeate spacer module wherein the membrane films, leaves or sheets, are attached on both sides of the spacer.

42. A membrane system according to claim 41, wherein the support members and the at least one inserted element being made of a membrane material, and the support members, the at least one inserted element, and the membrane films, leaves or sheets, on both sides of the permeate spacer module being made as one unit of a membrane material.

43. The membrane system according to claim 41, wherein the system also comprises at least one support list, or support strip.

44. The membrane system according to claim 41, wherein the membrane being at least partly welded, or at least partly glued on to the spacer.

45. A process for collecting permeates comprising following steps, i) contacting a membrane system to fluids, transferring permeates through a membrane; the membrane system having a permeate spacer module wherein the membrane films, leaves or sheets, are attached on both sides of the spacer; ii) creating a flow of permeates through flow space, passages or flow channels defined by the permeate spacer module; and iii) collecting the permeate in at least one permeate collecting device connected to the flow space, passages or the flow channels.

46. The process according to claim 45, wherein the process comprises a further step iv) transferring the permeates collected in step iii) by hydrostatic pressure to a collection tank, or a container, or a well.

47. A membrane system according to claim 41 for use in the treatment of wastewater, seawater, surface water or well water.

48. A membrane system according to claim 41 for use in sterile filtration, clarification, or concentration of high molecule weights.

49. A membrane system according to any one of claim 41 for use in the processing of wine, beer, fruit juice concentration, sterile filtration of milk.

50. A membrane plant comprising a membrane system having a permeate spacer module wherein the membrane films, leaves or sheets, are attached on both sides of the spacer; and
wherein the membrane plant also comprises a collection tank, or a container, or a well.

51. The membrane plant according to claim 50, wherein the membrane system is placed in a biological treatment tank.

52. The membrane plant according to claim 50, wherein the collection tank, or the container, or the well is connected to the membrane system outside the biological treatment tank and that the collected permeates from the at least one permeate collection device connected to the permeate spacer module are connected to the collection tank, or the container, or the well, and the permeates are transferred by hydrostatic pressure from the at least one permeate collection device connected to the permeate spacer module to the collection tank, or to the container, or to the well.

53. The membrane plant according to claim 52, wherein the plant also comprises a pump for transporting a part of the permeates from the collection tank, or the container, or the well back to the biological treatment tank.

54. The membrane plant according to claim 52, wherein the plant also comprises a pump for transporting a part of the permeate from the collection tank, or the container, or the well back to the biological treatment tank.

55. A membrane plant according to claim 50 for use in the treatment of waste water or water.

56. A plate and frame membrane comprising at least one membrane system having a permeate spacer module wherein the membrane films, leaves or sheets, are attached on both sides of the spacer.

57. A membrane bioreactor comprising at least one membrane system having a permeate spacer module wherein the membrane films, leaves or sheets, are attached on both sides of the spacer.
